(19) United States
(12) Patent Application Publication
(10) Pub. No.: US 2022/0171300 A1
(43) Pub. Date: Jun. 2, 2022

(54) TONER MELT-KNEADING APPARATUS AND TONER MELT-KNEADING SYSTEM

(71) Applicant: CANON KABUSHIKI KAISHA, Tokyo (JP)

(72) Inventors: Yosuke Iwasaki, Tokyo (JP); Junichi Tamura, Ibaraki (JP); Yuichi Mizo, Ibaraki (JP); Yasuhiro Noami, Tokyo (JP); Naotsugu Kaneko, Ibaraki (JP); Daiki Kawano, Ibaraki (JP)

(21) Appl. No.: 17/538,352

(22) Filed: Nov. 30, 2021

(30) Foreign Application Priority Data
Dec. 2, 2020 (JP) 2020-200389

(51) Int. Cl. G03G 9/08; G03G 15/10

(52) U.S. Cl. CPC G03G 9/081; G03G 15/104

(57) ABSTRACT

A toner melt-kneading apparatus to perform melt-kneading includes a kneading chamber, a discharge member connected to the kneading chamber, and a pressure gauge provided to the discharge member. The discharge member includes a flow passage having a substantially cylindrical shape and configured to pass a kneaded material. The pressure gauge includes a thermometer and includes a pressure-measuring portion disposed in the flow passage. D, d, and ϕ satisfy the following relationship, where a length of the flow passage is denoted as D, a distance from a discharge port in a downstream-side end portion of the discharge member to the pressure-measuring portion is denoted as d, and an inner diameter of the flow passage is denoted as ϕ, 0.020≤(d/D)/ϕ (herein, D>d).

### BACKGROUND

### Field

The present disclosure relates to a toner melt-kneaded material manufacturing apparatus and a toner melt-kneading system used for an electrophotographic system, an electrostatic recording system, an electrostatic printing system, and a toner jet system.

### Description of the Related Art

In recent years, electrophotographic system full-color copiers have become widespread, and application to a printing market also progresses. In the printing market, not only high image quality but also stability of tint and gloss being not changed are important. In particular, the gloss relates to toner viscosity. In the instance of a toner produced through a melt-kneading step and a pulverization step, since the toner viscosity is changed during the melt-kneading step, the toner viscosity is controlled in the melt-kneading step. Currently, the kneaded material is sampled at constant time intervals, and the viscosity thereof is measured. However, the viscosity is not measured between sampling, and there is an issue of strict control being unable to be performed.

It is conjectured that an ideal technique to control the kneaded-material viscosity during the melt-kneading step is in-line and real-time viscosity measurement. Since the toner kneaded material is in a high temperature state and has high viscosity, a capillary type or differential pressure type viscosity measuring technique is suitable. Regarding the capillary type or differential pressure type viscosity measurement, a Newtonian fluid is strictly measured, but viscosity measurement of a non-Newtonian fluid such as a toner is not strictly performed in principle. Therefore, to measure a non-Newtonian fluid in line, for example, a technique in which a kneaded material is temporarily stored and the viscosity is calculated while the flow rate in a capillary is controlled is adopted (Japanese Patent Laid-Open No. 2015-52547).

Regarding the technique according to Japanese Patent Laid-Open No. 2015-52547, it is possible to perform in-line viscosity measurement. However, since the kneaded material has to be temporarily stored, there is room for improvement from the viewpoint of requirement for real-time strict viscosity measurement.

### SUMMARY

The present disclosure relates to a toner melt-kneading apparatus in which melt-kneading is performed and which allows in-line and real-time viscosity measurement to be performed.

According to an aspect of the present disclosure, a toner melt-kneading apparatus to perform melt-kneading includes a kneading chamber, a discharge member connected to the kneading chamber, wherein the discharge member includes a flow passage having a substantially cylindrical shape and configured to pass a kneaded material, and a pressure gauge provided to the discharge member, wherein the pressure gauge includes a thermometer and includes a pressure-measuring portion disposed in the flow passage, wherein D, d, and ϕ satisfy the following relationship, where a length of the flow passage is denoted as D, a distance from a discharge port in a downstream-side end portion of the discharge member to the pressure-measuring portion is denoted as d, and an inner diameter of the flow passage is denoted as ϕ, 0.020≤(d/D)/ϕ (herein, D>d).

Further features of the present disclosure will become apparent from the following description of exemplary embodiments with reference to the attached drawings.

### BRIEF DESCRIPTION OF THE DRAWINGS

FIG. 1 is a diagram of a toner melt-kneading apparatus used in the related art.

FIG. 2 is a diagram of a toner melt-kneading apparatus used in the present disclosure.

### DESCRIPTION OF THE EMBODIMENTS

Regarding the viscosity control during a toner melt-kneading step in which melt-kneading was performed in a kneading chamber, the present inventors made improvements to enable in-line and real-time viscosity measurement to be performed and, as a result, found apparatus and a system that are capable of measuring viscosity in line and in real time by measuring a temperature and a pressure at a specific place of a kneading apparatus discharge portion. Specifically, a discharge member having a substantially cylindrical flow passage to pass a kneaded material is connected to the kneading chamber, the discharge member is provided with a pressure gauge including a pressure-measuring portion disposed in the flow passage and a thermometer, and D, d, and ϕ satisfy the following relationship, where the length of the flow passage is denoted as D, the distance from a discharge port in a downstream-side end portion of the discharge member to the pressure-measuring portion is denoted as d, and the inner diameter of the flow passage is denoted as ϕ,

0.020≤(d/D)/ϕ (herein, D>d).

A favorable toner melt-kneading apparatus and toner melt-kneading system in the present disclosure will be described below in detail.

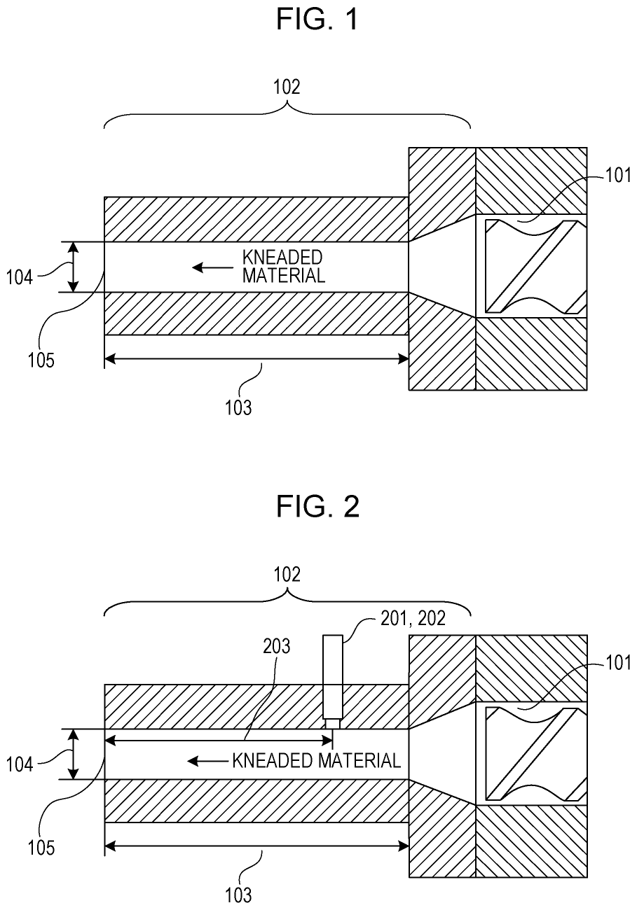

The outline of a commonly used toner melt-kneading apparatus will be described with reference to FIG. 1. FIG. 1 is a schematic sectional view. A kneaded material that has been met-kneaded in a kneading chamber 101 is extruded in the direction toward a discharge port 105 and is moved to a discharge member 102 having a substantially cylindrical flow passage to pass a kneaded material. The length of the flow passage is denoted as D103, the inner diameter of the flow passage is denoted as ϕ104, and the kneaded material passes through the substantially cylindrical flow passage and is discharged from the discharge port 105. The mainstream of such a melt-kneading apparatus is a uniaxial extruder or a twin-axial extruder, and examples include PCM two-axis extruder produced by Ikegai Corporation, KTK twin screw extruder produced by Kobe Steel, Ltd., TEM twin screw extruder produced by TOSHIBA MACHINE CO., LTD., Twin screw extruder produced by KCK, and Co-Kneader produced by Buss. These may be used without modification or after being appropriately modified.

Next, the outline of a toner melt-kneading apparatus used in the present disclosure will be described with reference to FIG. 2. Regarding the melt-kneading apparatus according to the present disclosure, it is important to add a pressure gauge 201 and a thermometer 202 to the discharge member of the toner melt-kneading apparatus as illustrated in FIG. 1. Consequently, the pressure and the temperature of a kneaded material in a flow passage are measured. As a result of research by the present inventors, it was ascertained that the pressure measured in the discharge member after kneading was changed due to the viscosity of the kneaded material. That is, this indicates that the principle of a differential pressure viscometer when the pressure of the discharge port is assumed to be zero is applicable to the melt-kneading apparatus discharge portion.

Regarding the set position of the above-described pressure gauge in the flow passage, the pressure gauge is set at a distance d203 from the discharge port in a downstream-side end portion of the discharge member to the pressure-measuring portion. To measure the viscosity of the kneaded material subjected to melt-kneading, it is important to set the pressure gauge, in the discharge member, at some distance from a kneading chamber in which kneading tends to have an influence. The effect of the present disclosure is obtained when the above-described D, ϕ, and d are within a predetermined range. If d is beyond the predetermined range, the pressure in the flow passage is not satisfactorily detected. This is because since discharge is performed while the discharge port is open to air, an influence of the pressure being zero at the discharge port is exerted. When the flow passage diameter ϕ is large, since the pressure is decreased, the pressure necessary in the present disclosure is not obtained. As a result of research by the present inventors, it was found that the pressure is satisfactorily measured when the value of (d/D)/ϕ was 0.020 or more. The upper limit is determined in accordance with the range in which just the pressure gauge is disposed in consideration of the size and the like. A plurality of pressure gauges may be disposed provided that the set positions are within a predetermined range, and a difference in the pressure may be taken as data. To sufficiently obtain the effect of the present disclosure, it is favorable that the diameter is not changed in the flow passage. If the flow passage diameter is changed, an influence of the material viscosity on the pressure is not sufficiently reflected.

Regarding the toner kneaded material that is a non-Newtonian fluid, more accurate viscosity is obtained by using not only the pressure value but also the temperature value. This is because the pressure of the toner kneaded material fluctuates due to the temperature. Therefore, regarding the apparatus, the temperature and the pressure being within controlled values enable the viscosity to be ensured.

Further, it is possible to calculate more precise viscosity on the basis of the values of the temperature, the pressure, and the viscosity.

There is no particular limitation regarding this technique, and a prediction formula can be constructed by a technique such as multivariate analysis. The method for calculating the viscosity by using a multivariate analysis technique will be described later. There is no particular limitation regarding the viscosity index, provided that the measurement value indicates the viscosity of the kneaded material. Examples include a softening point measured by using a flow tester or the like. In such an instance, the accuracy is further improved by intentionally changing the viscosity of the kneaded material by changing binder resins having different viscosities and the kneading condition and, by comparing the viscosity index at this time with the pressure and the temperature. The thermometer has to be disposed in the same region as the region of the pressure gauge and can be disposed at the same position. This is because the accuracy is improved by measuring the temperature of the pressure measurement position. From such a viewpoint, it is more favorable that a sensor in which a pressure gauge and a thermometer are integrated be used.

### Method for Producing Toner Kneaded Material

A procedure for producing the toner kneaded material by using the producing apparatus and the producing system according to the present disclosure will be described. Initially, in a raw material mixing step, predetermined amounts of at least one of a binder resin or a colorant, which serve as internal additives, are weighed and mixed so as to obtain a toner mixture. As the situation demands, a release agent to suppress hot offset from occurring during heat fixing of a toner, a dispersing agent to disperse the release agent, a charge control agent, and the like may be mixed. Examples of the mixing apparatus include double-cone mixers, V-type mixers, drum-type mixers, super mixers, Henschel mixers, and Nauta mixers.

In addition, the mixed toner raw material is melt-kneaded to melt resins and to disperse the colorant and the like in the resins. The apparatuses as described above may be used as the melt-kneading apparatus.

The melt-kneaded material obtained by melt-kneading the toner raw material is rolled with a two-roll or the like after melt-kneading and is cooled through a cooling step of performing cooling with water or the like. For the viscosity measurement, the cooled material of the melt-kneaded material obtained above may be used after being roughly crushed by a crusher mill, a hammer mill, a feather mill, or the like.

### Raw Material for Toner Kneaded Material

Next, the raw material for the toner kneaded material containing at least one of a binder resin or a colorant used in the present disclosure will be described.

### Binder Resin

A common resin may be used as the binder resin used for a toner, and examples of the resin include polyester resins, styrene-acrylic acid copolymers, polyolefin-based resins, vinyl-based resins, fluororesins, phenol resins, silicone resins, and epoxy resins. Of these, it is known that amorphous polyester resins are used from the viewpoint of facilitating the low-temperature fixability and that a low-molecular-weight polyester and a high-molecular-weight polyester are used in combination from the viewpoint of compatibility between the low-temperature fixability and the hot offset resistance. In addition, a crystalline polyester may be used as a plasticizer from the viewpoint of further improving low-temperature fixability and blocking resistance during storing.

### Colorant

Examples of the colorant contained in the toner include the following.

Examples of the colorant include known organic pigments or oil-based dyes, carbon black, and magnetic materials.

Examples of a cyan-based colorant include copper phthalocyanine compounds and derivatives thereof, anthraquinone compounds, and basic dye lake compounds. Examples of a magenta-based colorant include condensed azo compounds, diketopyrrolopyrrole compounds, anthraquinone compounds, quinacridone compounds, basic dye lake compounds, naphthol compounds, benzimidazolone compounds, thioindigo compounds, and perylene compounds. Examples of a yellow-based colorant include condensed azo compounds, isoindolinone compounds, anthraquinone compounds, azo metal complexes, methine compounds, and allylamide compounds. Examples of a black-based colorant include carbon black, magnetic materials, and colorants toned in black by using the yellow-based colorant, the magenta-based colorant, and the cyan-based colorant.

The colorants may be used alone, or at least two types may be used in combination.

### Release Agent

As the situation demands, a release agent to suppress hot offset from occurring during heat fixing of a toner may be used. In general, examples of the release agent include low-molecular-weight polyolefins, silicone waxes, fatty acid amides, ester waxes, carnauba waxes, and hydrocarbon-based waxes.

### Measurement and Analysis

Next, measurement techniques and analytical techniques used in the present disclosure will be described.

### Softening Point of Toner Melt-Kneaded Material

The softening point of the toner melt-kneaded material is measured by using a constant test force extrusion type capillary rheometer “Rheological characteristics evaluation apparatus Flowtester CFT-500D” (produced by SHIMADZU CORPORATION) in accordance with the manual attached to the apparatus. In the present apparatus, a measurement sample introduced in a cylinder is melted by increasing a temperature while a constant load is applied from above the measurement sample by using a piston, and the melted measurement sample is extruded from a die in the cylinder bottom portion so as to obtain a flow curve indicating the relationship between the amount of descent of piston and the temperature at this time.

In the present disclosure, “melting temperature based on the ½ method” described in the manual attached to “Rheological characteristics evaluation apparatus Flowtester CFT-500D” is denoted as the softening point. In this regard, the melting temperature based on the ½ method is calculated as described below. Initially, ½ of the difference between the amount of descent of piston Smax at the instance when flow is stopped and the amount of descent of piston Smin at the instance when flow is started is determined (the result is denoted as X; X=(Smax−Smin)/2). Consequently, the temperature of the flow curve at the point at which the amount of descent of piston is X on the flow curve is the melting temperature based on the ½ method.

About 1.0 g of toner melt-kneaded material is subjected to compression molding, in an environment of 25° C., by using a pellet forming compression machine (for example, NT-100H produced by NPa SYSTEM CO. LTD.) at about 10 MPa for about 60 seconds so as to be made into a cylindrical shape having a diameter of about 8 mm and is used as the measurement sample. Thereafter, the sample is left to stand in an environment of at 23° C. and 5% RH for 24 hours, and the measurement is performed.

The measurement conditions for CFT-500 are as described below.

Test mode: heating-rate method
Start temperature: 40° C.
Final temperature: 200° C.
Measurement interval: 1.0° C.
Heating rate: 4.0° C./min
Piston cross-sectional area: 1.000 cm²
Test force (piston load): 10.0 kgf (0.9807 MPa)
Preheating time: 300 seconds
Die hole diameter: 1.0 mm
Die length: 1.0 mm

### Viscosity Calculation Method by Multivariate Analysis

Kneading is performed in which the viscosity of the raw material and the kneading condition are changed. The shear stress applied to the kneaded material is changed by changing the condition, and the viscosity of the kneaded material is changed. The temperature and the pressure in the discharge member which are important in the present disclosure are measured during kneading. The kneaded material is roughly crushed, and the softening point is measured by using the above-described technique. The measured temperature and pressure are used as variables, and a relational expression to represent the softening point is derived by using a regression analysis technique. In the present disclosure, a softening point prediction formula is derived by using a regression analysis function of Excel.

### EXAMPLES

### Production Example of Binder Resin Polyester 1

Polyoxypropylene(2,2)-bis(4-hydroxyphenyl)propane: 72.0 parts by mass (0.20 mol; 100.0% by mole relative to the total number of moles of polyhydric alcohol)
Terephthalic acid: 28.0 parts by mass (0.17 mol; 100.0% by mole relative to the total number of moles of polyvalent carboxylic acid)
Tin 2-ethylhexanoate (esterification catalyst): 0.5 parts by mass

The above-described materials were weighed into a reaction vessel provided with a cooling pipe, an agitator, a nitrogen gas introduction pipe, and a thermocouple.

After the interior of the reaction vessel was substituted with nitrogen gas, the temperature was gradually increased under agitation, and a reaction was performed at a temperature of 220° C. for 8 hours under agitation.

The pressure in the reaction vessel was reduced to 8.3 kPa and maintained for 1 hour. Thereafter, cooling to 180° C. was performed, and the pressure was returned to an atmospheric pressure.

Trimellitic anhydride: 3 parts by mass (0.01 mol; 4.0% by mole relative to the total number of moles of polyvalent carboxylic acid) tert-Butylcatechol (polymerization inhibitor): 0.1 parts by mass

Subsequently, the above-described materials were added, the pressure in the reaction vessel was reduced to 8.3 kPa, and a reaction was performed for 1 hour while the temperature of 180° C. was maintained so as to obtain a binder resin. The softening point of the resulting binder resin measured in accordance with ASTM D36-86 was 110° C.

### Production Example of Binder Resin Polyester 2

Production was performed in the same manner as polyester resin 1 except that the second reaction time was changed to 0.5 hours. The softening point was 107° C.

### Production Example of Binder Resin Polyester 3

Production was performed in the same manner as polyester resin 1 except that the second reaction time was changed to 1.5 hours. The softening point was 113° C.

### Production Example of Toner Mixture 1

Binder resin polyester 1: 90 parts by mass
Fisher-Tropsch wax (hydrocarbon wax, peak temperature of maximum endothermic peak of 90° C.): 5 parts by mass
C.I. Pigment Blue 15:3: 5 parts by mass

The above-described materials were mixed by using a Henschel mixer (Model FM-75 produced by Mitsui Mining Co., Ltd.) with the number of revolutions of 20 s⁻¹ and the rotation time of 5 min so as to obtain toner mixture 1.

### Production Example of Toner Mixture 2

Toner mixture 2 was obtained in the same manner as toner mixture 1 except that the binder resin polyester was changed to binder resin polyester 2.

### Production Example of Toner Mixture 3

Toner mixture 3 was obtained in the same manner as toner mixture 1 except that the binder resin polyester was changed to binder resin polyester 3.

### Example 1

In example 1, a two-axis extruder (Model PCM-30 produced by Ikegai Corporation) including a modified discharge member was used. Regarding a sensor in which a thermometer and a pressure gauge were integrated, an MP432 Series (produced by Dynisco, sensor diameter of 10 mm) was used. Regarding a sensor of a pressure gauge alone, an MP420 Series (produced by Dynisco, sensor diameter of 10 mm) was used. Regarding a sensor of thermometer alone, a J-type thermocouple was used. The length D of the flow passage, the distance d from a discharge port in a downstream-side end portion of the discharge member to the pressure-measuring portion, the distance e of the thermometer from the discharge port in the downstream-side end portion of the discharge member to the pressure-measuring portion, and the inner diameter ϕ of the flow passage were set to be as described in Table 1 so as to prepare apparatuses 1 to 10.

Toner mixtures 1 to 3 were used. Kneading was performed for 30 minutes by using each of apparatuses 1 to 10 in which the rotational speed was set to be 200 rpm, the feed was set to be 10 kg/h, and the barrel temperature was set to be 120° C. so as to obtain toner kneaded materials 1 to 3.

Herein, regarding the setting, the pressure and the temperature were measured once every 0.2 sec, and the average value of 1 sec (5 points) was output every 1 sec. The pressure and the temperature output during kneading were checked, and the average value of the pressure and the average value of the temperature of each of toner kneaded materials 1 to 3 were calculated. When at least one of the values of the pressure and the temperature of toner kneaded material 1 was larger than the respective average values of toner kneaded material 2 and toner kneaded material 3, it was determined that the apparatus was not suitable for the measurement since variations were excessively large. The results are expressed as “acceptable” or “unacceptable” and described in Table 1.

### Comparative Example 1

In comparative example 1, a two-axis extruder (Model PCM-30 produced by Ikegai Corporation) including a modified discharge member akin to that in example 1 was used. Apparatuses 11 to 14 in which changes were made as described in Table 1 were prepared.

Toner mixtures 1 to 3 were used. Kneading was performed by using each of apparatuses 11 to 14 in the same manner as in example 1 so as to obtain toner kneaded materials 1 to 3, and the evaluation akin to that in example 1 was performed. The results are expressed as “acceptable” or “unacceptable” and described in Table 1.

TABLE 1

| | | | | | | | Average |
|---|---|---|---|---|---|---|---|
| | | | | Pressure | | | temperature |
| | | | | gauge d | Thermometer | | of kneaded |
| Example No. | Apparatus No. | D (mm) | ϕ (mm) | (mm) | e (mm) | (d/D)/ϕ | material 2 (° C.) |
| Example 1 | apparatus 1 | 200 | 15 | 150 | 150 | 0.050 | 124 |
| | apparatus 2 | 200 | 15 | 150 | 100 | 0.050 | 121 |
| | apparatus 3 | 200 | 12 | 150 | 150 | 0.063 | 125 |
| | apparatus 4 | 200 | 32 | 150 | 150 | 0.023 | 122 |
| | apparatus 5 | 200 | 15 | 75 | 75 | 0.025 | 122 |
| | apparatus 6 | 200 | 15 | 190 | 190 | 0.063 | 126 |
| | apparatus 7 | 60 | 15 | 45 | 45 | 0.050 | 124 |
| | apparatus 8 | 280 | 15 | 210 | 210 | 0.050 | 122 |
| | apparatus 9 | 200 | 12 | 60 | 60 | 0.025 | 124 |
| | apparatus 10 | 200 | 40 | 190 | 190 | 0.024 | 123 |
| Comparative | apparatus 11 | 200 | 40 | 150 | 150 | 0.019 | 122 |
| example 1 | apparatus 12 | 200 | 15 | 40 | 40 | 0.013 | 121 |
| | apparatus 13 | 200 | 15 | 220 | 220 | — | 124 |
| | apparatus 14 | 200 | 15 | none | none | — | no thermometer |

| | Average | Average | Average | Maximum | Maximum | Minimum | Minimum | |
|---|---|---|---|---|---|---|---|---|
| | pressure of | temperature of | pressure of | temperature of | pressure of | temperature | pressure of | |
| | kneaded | kneaded | kneaded | kneaded | kneaded | of kneaded | kneaded | |
| | material 2 | material 3 | material 3 | material 1 | material 1 | material 1 | material 1 | |
| Example No. | (MPa) | (° C.) | (MPa) | (° C.) | (MPa) | (° C.) | (MPa) | Evaluation |
| Example 1 | 0.22 | 126 | 0.33 | 126 | 0.31 | 125 | 0.24 | acceptable |
| | 0.21 | 125 | 0.33 | 125 | 0.30 | 122 | 0.22 | acceptable |
| | 0.24 | 127 | 0.36 | 126 | 0.34 | 125 | 0.25 | acceptable |
| | 0.23 | 126 | 0.30 | 126 | 0.29 | 123 | 0.24 | acceptable |
| | 0.10 | 124 | 0.22 | 124 | 0.20 | 122 | 0.12 | acceptable |
| | 0.26 | 127 | 0.37 | 126 | 0.35 | 126 | 0.28 | acceptable |
| | 0.19 | 127 | 0.30 | 127 | 0.29 | 124 | 0.21 | acceptable |
| | 0.23 | 125 | 0.34 | 124 | 0.31 | 122 | 0.22 | acceptable |
| | 0.20 | 127 | 0.31 | 127 | 0.29 | 124 | 0.23 | acceptable |
| | 0.20 | 125 | 0.31 | 125 | 0.28 | 123 | 0.22 | acceptable |
| Comparative | 0.00 | 126 | 0.10 | 125 | 0.07 | 123 | 0.00 | unacceptable |
| example 1 | 0.00 | 125 | 0.08 | 125 | 0.06 | 122 | 0.00 | unacceptable |
| | 0.31 | 128 | 0.39 | 129 | 0.42 | 124 | 0.25 | unacceptable |
| | no pressure | no | no pressure | no | no pressure | no | no pressure | unacceptable |
| | gauge | thermometer | gauge | thermometer | gauge | thermometer | gauge | |

Regarding apparatus 11, ϕ was excessively large, and the value of (d/D)/ϕ was 0.019 and was small. Consequently, it is conjectured that the pressure was not smoothly detected and that the effect of the present disclosure was unable to be exerted.

Regarding apparatus 12, the sensor position was excessively close to the discharge port, and the value of (d/D)/ϕ was 0.013 and was small. Consequently, it is conjectured that the pressure was not smoothly detected and that the effect of the present disclosure was unable to be exerted.

Regarding apparatus 13, the sensor was disposed in a portion that was not a straight pipe portion. Since this portion was close to the kneading chamber and the flow passage was narrowed in this portion, the pressure was considerably influenced by a screw pitch of the kneader, and pressure measurement in accordance with the viscosity was unable to be performed. Consequently, it is conjectured that the pressure was not smoothly detected and that the effect of the present disclosure was unable to be exerted.

Apparatus 14 included no pressure gauge nor thermometer. Since a sensor to detect the pressure corresponding to the viscosity was not provided, the effect of the present disclosure was not obtained.

### Example 2

In example 2, the apparatuses 1 To 10 in example 1 were prepared as a kneader.

Kneading was performed under the condition described in Table 2, that is, the condition 1 to the condition 9, and the pressure P and the temperature T at that time were output. In addition, the softening point of the kneaded material was measured, the regression analysis was performed in which the softening point of the kneaded material was the response variable, and the pressure P and the temperature T were the explanatory variables, and a prediction formula was derived. Further, a value of the coefficient of determination R² when the horizontal axis represents the prediction formula and the vertical axis represents the measured value was calculated. When the value of the coefficient of determination R² was 0.80 or more, it was evaluated that the effect of the present disclosure was obtained.

The evaluation ranks are as described below.

A: There is substantially no difference between the predicted value and the measured value, and the result is very excellent.
B: There is a slight difference between the predicted value and the measured value, but the difference is at a level that practically causes no issue.
C: There is a difference between the predicted value and the measured value, but the difference is at a level that practically causes no issue.
D: There is a difference between the predicted value and the measured value, and an issue occurs in practical use. Alternatively, a predicted value is unavailable.
A: R²=0.90 or more
B: R²=0.85 or more and less than 0.90
C: R²=0.80 or more and less than 0.85
D: R²=less than 0.80 or a predicted value is unavailable

The results are described in Table 3.

### Comparative Example 2

In comparative example 2, the apparatuses 11 to 14 in comparative example 1 were prepared as a kneader. The evaluation technique was akin to that in example 1. The results are described in Table 3.

TABLE 2

| | | Rotational | Feed | Barrel |
|---|---|---|---|---|
| Condition No. | Mixture | speed (rpm) | (kg/h) | temperature (° C.) |
| Condition 1 | Mixture 1 | 200 | 10 | 140 |
| Condition 2 | Mixture 1 | 100 | 10 | 140 |
| Condition 3 | Mixture 1 | 300 | 10 | 140 |
| Condition 4 | Mixture 1 | 200 | 5 | 140 |
| Condition 5 | Mixture 1 | 200 | 15 | 140 |
| Condition 6 | Mixture 1 | 200 | 10 | 120 |
| Condition 7 | Mixture 1 | 200 | 10 | 160 |
| Condition 8 | Mixture 2 | 200 | 10 | 140 |
| Condition 9 | Mixture 3 | 200 | 10 | 140 |

TABLE 3

| | | | | Pressure | | | | | | |
|---|---|---|---|---|---|---|---|---|---|---|
| | | | | gauge d | Thermometer | | | | | |
| | Apparatus No. | D (mm) | ϕ (mm) | (mm) | e (mm) | (d/D)/ϕ | | | Condition 1 | |
| Example 2 | apparatus 1 | 200 | 15 | 150 | 150 | 0.050 | predicted value | | 111 | |
| | | | | | | | measured value | | 111 | |
| | apparatus 2 | 200 | 15 | 150 | 100 | 0.050 | predicted value | | 110 | |
| | | | | | | | measured value | | 111 | |
| | apparatus 3 | 200 | 12 | 150 | 150 | 0.063 | predicted value | | 110 | |
| | | | | | | | measured value | | 111 | |
| | apparatus 4 | 200 | 32 | 150 | 150 | 0.023 | predicted value | | 113 | |
| | | | | | | | measured value | | 112 | |
| | apparatus 5 | 200 | 15 | 75 | 75 | 0.025 | predicted value | | 112 | |
| | | | | | | | measured value | | 111 | |
| | apparatus 6 | 200 | 15 | 190 | 190 | 0.063 | predicted value | | 111 | |
| | | | | | | | measured value | | 111 | |
| | apparatus 7 | 60 | 15 | 45 | 45 | 0.050 | predicted value | | 109 | |
| | | | | | | | measured value | | 111 | |
| | apparatus 8 | 280 | 15 | 210 | 210 | 0.050 | predicted value | | 112 | |
| | | | | | | | measured value | | 111 | |
| | apparatus 9 | 200 | 12 | 60 | 60 | 0.025 | predicted value | | 110 | |
| | | | | | | | measured value | | 110 | |
| | apparatus 10 | 200 | 40 | 190 | 190 | 0.024 | predicted value | | 112 | |
| | | | | | | | measured value | | 111 | |
| Comparative | apparatus 11 | 200 | 40 | 150 | 150 | 0.019 | predicted value | | | |
| example 2 | | | | | | | measured value | | 111 | |
| | apparatus 12 | 200 | 15 | 40 | 40 | 0.013 | predicted value | | | |
| | | | | | | | measured value | | 110 | |
| | apparatus 13 | 200 | 15 | 220 | 220 | — | predicted value | | 110 | |
| | | | | | | | measured value | | 111 | |
| | apparatus 14 | 200 | 15 | none | none | — | predicted value | | | |
| | | | | | | | measured value | | 111 | |
| | Condition | Condition | Condition | Condition | Condition | Condition | Condition | Condition | R² | |
| | 2 | 3 | 4 | 5 | 6 | 7 | 8 | 9 | value | Evaluation |
| Example 2 | 113 | 109 | 111 | 108 | 108 | 115 | 108 | 116 | 0.91 | A |
| | 113 | 109 | 110 | 110 | 108 | 114 | 108 | 114 | | |
| | 112 | 108 | 110 | 110 | 110 | 113 | 107 | 114 | 0.90 | A |
| | 113 | 109 | 111 | 110 | 109 | 114 | 108 | 114 | | |
| | 112 | 111 | 110 | 110 | 109 | 114 | 107 | 115 | 0.89 | B |
| | 113 | 110 | 111 | 110 | 108 | 114 | 108 | 115 | | |
| | 114 | 109 | 113 | 111 | 110 | 115 | 109 | 113 | 0.85 | B |
| | 113 | 109 | 111 | 110 | 108 | 114 | 108 | 114 | | |
| | 116 | 111 | 112 | 112 | 107 | 115 | 110 | 113 | 0.82 | C |
| | 114 | 109 | 111 | 110 | 107 | 114 | 107 | 114 | | |
| | 114 | 108 | 110 | 110 | 109 | 115 | 109 | 113 | 0.86 | B |
| | 113 | 109 | 111 | 110 | 108 | 114 | 108 | 114 | | |
| | 110 | 108 | 110 | 109 | 109 | 113 | 107 | 112 | 0.80 | C |
| | 113 | 109 | 111 | 110 | 108 | 114 | 108 | 114 | | |
| | 112 | 109 | 111 | 111 | 109 | 113 | 106 | 114 | 0.90 | A |
| | 112 | 109 | 111 | 110 | 108 | 114 | 107 | 114 | | |
| | 112 | 109 | 112 | 107 | 108 | 115 | 107 | 114 | 0.89 | B |
| | 113 | 109 | 111 | 109 | 108 | 114 | 108 | 115 | | |
| | 114 | 108 | 111 | 111 | 108 | 113 | 108 | 113 | 0.87 | B |
| | 113 | 109 | 111 | 110 | 107 | 114 | 108 | 114 | | |
| Comparative | measurement was impossible | | | | | | | | calculation | D |
| example 2 | 112 | 109 | 110 | 110 | 108 | 115 | 108 | 114 | was | |
| | | | | | | | | | impossible | |
| | measurement was impossible | | | | | | | | calculation | D |
| | 112 | 109 | 109 | 111 | 108 | 114 | 108 | 115 | was | |
| | | | | | | | | | impossible | |
| | 112 | 112 | 114 | 108 | 105 | 112 | 107 | 114 | 0.55 | D |
| | 112 | 109 | 111 | 110 | 108 | 114 | 108 | 114 | | |
| | measurement was impossible | | | | | | | | calculation | D |
| | 113 | 110 | 111 | 109 | 108 | 115 | 108 | 113 | was | |
| | | | | | | | | | impossible | |

Regarding apparatus 11, ϕ was excessively large, and the value of (d/D)/ϕ was 0.019 and was small. Consequently, it is conjectured that the pressure was not smoothly detected and that the effect of the present disclosure was unable to be exerted.

Regarding apparatus 12, the sensor position was excessively close to the discharge port, and the value of (d/D)/ϕ was 0.013 and was small. Consequently, it is conjectured that the pressure was not smoothly detected and that the effect of the present disclosure was unable to be exerted.

Regarding apparatus 13, the sensor was disposed in a portion that was not a straight pipe portion. Since this portion was close to the kneading chamber and the flow passage was narrowed in this portion, the pressure was considerably influenced by a screw pitch of the kneader, and pressure measurement in accordance with the viscosity was unable to be accurately performed. It is conjectured that a large difference between the predicted value and the measured value occurred and the effect of the present disclosure was unable to be exerted.

Apparatus 14 included no pressure gauge nor thermometer. Since a sensor to detect the pressure corresponding to the viscosity was not provided, the effect of the present disclosure was not obtained.

In the toner kneading step, in-line and real-time viscosity measurement is made possible.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-200389 filed Dec. 2, 2020, which is hereby incorporated by reference herein in its entirety.

What is claimed is:

1. A toner melt-kneading apparatus to perform melt-kneading, the toner melt-kneading apparatus comprising:
a kneading chamber;
a discharge member connected to the kneading chamber, wherein the discharge member includes a flow passage having a substantially cylindrical shape and configured to pass a kneaded material; and
a pressure gauge provided to the discharge member, wherein the pressure gauge includes a thermometer and includes a pressure-measuring portion disposed in the flow passage,
wherein D, d, and ϕ satisfy the following relationship, where a length of the flow passage is denoted as D, a distance from a discharge port in a downstream-side end portion of the discharge member to the pressure-measuring portion is denoted as d, and an inner diameter of the flow passage is denoted as ϕ,
$$0.020 \leq ( d / D ) / ϕ ( herein , D > d ) .$$

2. The toner melt-kneading apparatus according to claim 1, wherein the pressure gauge and the thermometer are integrated.

3. A toner melt-kneading system to perform melt-kneading, the toner melt-kneading system comprising:
a calculation unit configured to calculate a viscosity index of a kneaded material based on a relational expression in which variables are a measured pressure P and a temperature T and which is derived by using a multivariate analysis technique;
a kneading chamber;
a discharge member connected to the kneading chamber, wherein the discharge member includes a flow passage having a substantially cylindrical shape and configured to pass the kneaded material; and
a pressure gauge provided to the discharge member, wherein the pressure gauge includes a thermometer and includes a pressure-measuring portion disposed in the flow passage,
wherein D, d, and ϕ satisfy the following relationship, where a length of the flow passage is denoted as D, a distance from a discharge port in a downstream-side end portion of the discharge member to the pressure-measuring portion is denoted as d, and an inner diameter of the flow passage is denoted as ϕ,
$$0.020 \leq ( d / D ) / ϕ ( herein , D > d ) .$$

4. The toner melt-kneading system according to claim 3, wherein the pressure gauge and the thermometer are integrated.
